(19) United States
(12) Patent Application Publication
(10) Pub. No.: US 2020/0399510 A1
(43) Pub. Date: Dec. 24, 2020

(54) PRESSURE-SENSITIVE ADHESIVE COMPOSITION AND PRESSURE-SENSITIVE ADHESIVE SHEET

(71) Applicant: NITTO DENKO CORPORATION, Ibaraki-shi, Osaka (JP)

(72) Inventors: Kenji FURUTA, Ibaraki-shi, Osaka (JP); Tatsuya SUZUKI, Ibaraki-shi, Osaka (JP); Minami WATANABE, Ibaraki-shi, Osaka (JP)

(21) Appl. No.: 16/956,817

(22) PCT Filed: Dec. 27, 2018
(86) PCT No.: PCT/JP2018/048368

§ 371 Date: Jun. 22, 2020

(30) Foreign Application Priority Data
Dec. 28, 2017 (JP) 2017-253955
Jun. 15, 2018 (JP) 2018-114937

(51) Int. Cl. C09J 119/00; C09J 109/00

(52) U.S. Cl. CPC C09J 119/00; C09J 109/00

(57) ABSTRACT

Provided is a PSA composition capable of achieving excellent moisture resistance.

The PSA composition provided by the present invention comprises a polymer A and a polymer B different from the polymer A. In each of the polymer A and the polymer B, isobutylene is polymerized at a ratio of 50% by weight or higher.

### TECHNICAL FIELD

The present invention relates to a pressure-sensitive adhesive composition and a pressure-sensitive adhesive sheet.

The present invention claims priority to Japanese Patent Applications No. 2017-253955 filed on Dec. 28, 2017 and No. 2018-114937 filed on Jun. 15, 2018; and the entire content thereof is incorporated herein by reference.

### BACKGROUND ART

In general, pressure-sensitive adhesive (PSA) exists as a soft solid (a viscoelastic material) in a room temperature range and has a property to adhere easily to an adherend with some pressure applied. For such a property, PSA is widely used in a form of, for instance, an on-substrate PSA sheet having a PSA layer on a support substrate, for purposes such as bonding, fastening, protection and sealing in various applications such as electronic devices. For instance, technical literatures related to PSA sheets that airtightly seal internal spaces of magnetic disc devices include Patent Documents 1 to 3. In this application, because the allowable maximum temperature is limited, PSA that does not require heat for press-bonding is preferably used as the bonding means.

### CITATION LIST

### Patent Literature

[Patent Document 1] Japanese Patent Application Publication No. 2014-162874

[Patent Document 2] Japanese Patent Application Publication No. 2017-014478

[Patent Document 3] Japanese Patent Application Publication No. 2017-160417

### SUMMARY OF INVENTION

### Technical Problem

For instance, the conventional PSA sheets all comprise non-breathable substrates and are used in magnetic disc devices such as hard disc drives (HDD), in embodiments to seal their internal spaces where magnetic discs (typically HD) are contained. In particular, a void space that can be present between a cover member and a housing base member in which the magnetic disc is placed can be covered and sealed with a PSA sheet so as to obtain airtightness for the internal space of the device. Such airtight properties may be essential and particularly important in a type of device whose internal space is filled with a low-density gas such as helium in order to reduce the influence of air flow generated by the spinning disc. In an embodiment using the PSA sheet, the sealing structure can be made thinner than in a conventional magnetic disc device for which airtightness has been assured with a gasket; and therefore, this embodiment is advantageous in increasing the density and capacity of a magnetic disc device. This embodiment does not require use of a liquid gasket. Thus, it can mitigate outgassing (gas emission) problems due to gasket.

Lately, studies are underway on magnetic disc devices using HAMR (heat-assisted magnetic recording) for further increases in capacity. In short, HAMR is a technology that uses a laser beam to increase their surface recording densities. In this technology, the presence of internal moisture attenuates the laser beam and badly impacts on the recording life (the number of times that it can be overwritten). Thus, it is desirable to exclude moisture as much as possible. About this aspect, in Patent Documents 2 and 3, cup methods are used to test moisture permeability of PSA sheets having aluminum layers. From the standpoint of producing higher-capacity, higher-quality magnetic disc devices, greater moisture resistance is required of a PSA sheet used in this application.

The present invention has been made in view of these circumstances with an objective to provide a PSA composition capable of bringing about excellent moisture resistance. Another related objective of this invention is to provide a PSA sheet.

### Solution to Problem

The present description provides a PSA composition comprising a polymer A and a polymer B different from the polymer A. In the PSA composition, in each of the polymer A and the polymer B, isobutylene is polymerized at a ratio of 50% by weight or higher (i.e. the polymer A and the polymer B are individually formed with at least 50% (by weight) polymerized isobutylene). With the PSA composition, it is possible to obtain a PSA sheet having excellent moisture resistance. A typical example of the polymer A is polyisobutylene.

In a preferable embodiment of the art disclosed herein (including PSA compositions, PSA sheets, magnetic disc devices and others; the same applies, hereinafter), in addition to the isobutylene, isoprene is copolymerized in the polymer B. With the use of the polymer B, the effect of the art disclosed herein is preferably obtained. A typical example of the polymer B is butyl rubber.

In a preferable embodiment of the art disclosed herein, the polymer A has a weight average molecular weight in the range between 1×10⁴ and 80×10⁴. According to an embodiment that includes a polymer A having a weight average molecular weight (Mw) in this range, moisture resistance and adhesive properties can be preferably combined.

In a preferable embodiment of the art disclosed herein, the polymer B has a weight average molecular weight in the range between 5×10⁴ and 150×10⁴. According to an embodiment that includes a polymer B having a Mw in this range, moisture resistance and adhesive properties can be preferably combined.

In a preferable embodiment of the art disclosed herein, the ratio (M_{B}/M_{A}) of the polymer B's weight average molecular weight M_{B} to the polymer A's weight average molecular weight M_{A} has a value in the range between 5 and 100. With the combined use of polymers A and B satisfying the M_{B}/M_{A} ratio value range, moisture resistance and adhesive properties can be well balanced with improvements.

In a preferable embodiment of the art disclosed herein, the ratio (C_{A}/C_{B}) of the polymer A content C_{A} to the polymer B content C_{B} is in the range between 70/30 and 30/70. When it has a composition satisfying the C_{A}/C_{B} weight ratio, greater moisture resistance can be obtained.

In a preferable embodiment of the art disclosed herein, the combined amount of the polymer A and the polymer B accounts for 90% by weight or more of the solid content (non-volatiles) of the PSA composition. When it has such a composition, the effect of the art disclosed herein is preferably obtained.

The PSA composition disclosed herein may form a PSA having excellent moisture resistance; and therefore, it is preferably used for sealing an internal space of a magnetic disc device for which entry of moisture needs to be limited.

The present description also provides a PSA sheet having a PSA layer comprising a polymer A and a polymer B different from the polymer A. In each of the polymer A and the polymer B in the PSA layer, isobutylene is polymerized at a ratio of 50% by weight or above. According to the PSA sheet, excellent moisture resistance is obtained.

In a preferable embodiment, the PSA sheet disclosed herein has a moisture permeability of 90 μg/cm²·24 h in in-plane direction of bonding interface, determined at a permeation distance of 2.5 mm based on a MOCON method. The PSA sheet satisfying this property has excellent moisture resistance. Thus, it can be preferably used in an application for which the presence of moisture and volatile gas is not desirable. For instance, when the PSA sheet disclosed herein is used as a sealing material in a magnetic disc device, it is possible to greatly limit changes (typically increases) in internal humidity that may affect the normal and highly precise operation of the device.

The PSA sheet according to a preferable embodiment has an amount of thermally released gas of 10 μg/cm² or less, determined at 130° C. for 30 minutes by gas chromatography/mass spectrometry (GC-MS). The amount of gas thermally released by the PSA sheet is highly limited as well; and therefore, it can be preferably used in an application for which the presence of moisture and volatile gas is undesirable. For instance, when the PSA sheet disclosed herein is used as a sealing material in a magnetic disc device, it is possible to greatly limit changes (typically increases) in internal humidity that may affect the normal and highly precise operation of the device as well as introduction of gas (siloxane gas, etc.) into the system.

The PSA sheet according to a preferable embodiment has a 180° peel strength (adhesive strength) of 3 N/20 mm or greater to a stainless steel plate. For instance, when the PSA sheet is used to seal the internal space of a sort of magnetic disc device, the PSA sheet having such adhesive strength can adhere well to the adherend, providing good sealing properties.

In a preferable embodiment of the PSA sheet disclosed herein, the PSA layer has a storage modulus G′(25° C.) less than 0.5 MPa (more specifically 0.09 MPa or greater and 0.29 MPa or less) at 25° C. With the use of the PSA layer having a storage modulus G′(25° C.) of at least the prescribed value (more specifically in the prescribed range), the PSA layer is highly wet and tightly adheres to the adherend's surface, whereby excellent moisture resistance is likely to be obtained.

The PSA sheet according to a preferable embodiment shows a displacement less than 2 mm in a shear holding power test carried out with a 1 kg load at 60° C. for one hour. The PSA sheet satisfying this property can provide good holding power even when used at a relatively high temperature.

The PSA sheet disclosed herein has excellent moisture resistance. Thus, it is preferably used for sealing the internal space of a magnetic disc device where entry of moisture needs to be limited. The art disclosed herein provides a magnetic disc device comprising a PSA sheet disclosed herein. The PSA sheet may serve to seal the internal space of the magnetic disc device. In the magnetic disc device in such an embodiment, the PSA sheet is relatively thin, yet provides moisture resistance and airtight properties; and therefore, as compared to a conventional gasket-type product, the capacity can be further increased. In particular, with the use of the PSA sheet disclosed herein in a HAMR magnetic disc device, a magnetic recording device having a higher density can be obtained.

### BRIEF DESCRIPTION OF DRAWINGS

FIG. 1 shows a cross-sectional diagram schematically illustrating a constitutional example of the PSA sheet.

FIG. 2 shows a schematic diagram of the moisture permeability measurement method.

FIG. 3 shows an enlarged top view of a sample used in determining the moisture permeability.

FIG. 4 shows a cross-sectional diagram schematically illustrating the magnetic disc device according to an embodiment.

FIG. 5 shows a cross-sectional diagram schematically illustrating the magnetic disc device according to another embodiment.

### DESCRIPTION OF EMBODIMENTS

Preferable embodiments of the present invention are described below. Matters necessary to practice this invention other than those specifically referred to in this description can be understood by a person skilled in the art based on the disclosure about implementing the invention in this description and common technical knowledge at the time the application was filed. The present invention can be practiced based on the contents disclosed in this description and common technical knowledge in the subject field. In the drawings referenced below, a common reference numeral may be assigned to members or sites producing the same effects, and redundant descriptions are sometimes omitted or simplified. The embodiments described in the drawings are schematized for clear illustration of the present invention, and do not necessarily represent the accurate size or reduction scale of an actual product of the PSA sheet or magnetic disc device of this invention or of the moisture permeability measurement device.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamentals and Practice” by C. A. Dahlquist (McLaren & Sons (1966), P. 143), in general, PSA referred to herein can be a material that has a property satisfying complex tensile modulus E* (1 Hz)<10⁷ dyne/cm² (typically, a material that exhibits the described characteristics at 25° C.).

The concept of PSA sheet herein may encompass so-called PSA tape, PSA labels, PSA film, etc. The PSA sheet disclosed herein can be in a roll or in a flat sheet. Alternatively, the PSA sheet may be processed into various shapes.

### <Constitution of PSA Sheet>

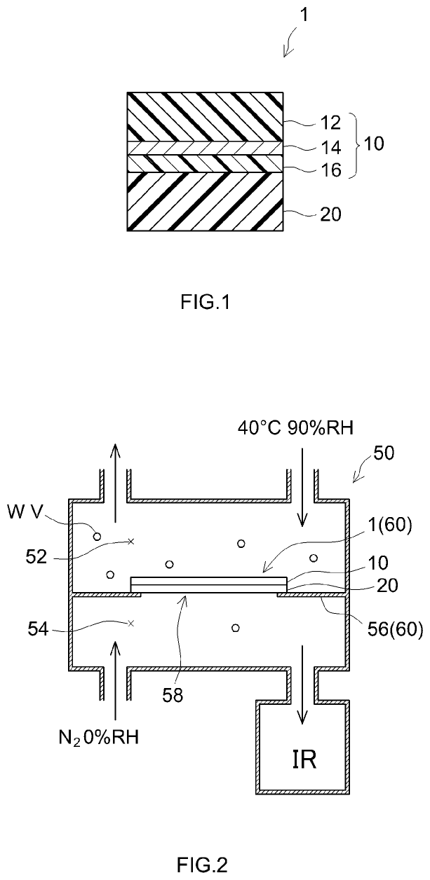

The PSA sheet disclosed herein can be, for instance, an adhesively single-faced PSA sheet having a cross-sectional structure as shown in FIG. 1. A PSA sheet 1 comprises a substrate layer 10 and a PSA layer 20 supported on a first face of substrate layer 10. In particular, substrate layer 10 is a layered body (laminate film) in which a first resin layer 12, an inorganic layer 14 and a second resin layer 16 are layered in this order; and it is a moisture-impermeable layer that is impermeable to moisture in the thickness direction. The first resin layer 12 placed on the first face side of inorganic layer 14 forms an outer surface of PSA sheet 1 while the second resin layer 16 is placed on the second face side of inorganic layer 14, that is, the PSA layer 20 side. From the standpoint of the moisture resistance, PSA layer 20 is formed continuously over the entire first face of substrate layer 10 at least in the area that bonds to an adherend. PSA sheet 1 prior to use (before applied to the adherend) may be protected with a release liner (not shown in the drawing) having a release face at least on the PSA layer 20 side surface.

### <PSA Composition>

### (Polymer A)

The PSA composition (and even the PSA layer; the same applies hereinafter unless otherwise noted) comprises a polymer A. The polymer A is an isobutylene-based polymer in which an isobutylene is polymerized, accounting for 50% by weight or more thereof. As used herein, the term “isobutylene-based polymer” is not limited to isobutylene homopolymer (homo-isobutylene); it also encompasses a copolymer whose primary monomer is isobutylene (a copolymer primarily formed of isobutylene). Due to their molecular structures, isobutylene-based polymers are highly hydrophobic and their main chains have low mobility. Thus, a PSA layer formed from a PSA composition comprising an isobutylene-based polymer may have relatively low moisture permeability on its own. This is advantageous from the standpoint of preventing water vapor from permeating through the lateral surface of the PSA layer at an edges face of the PSA sheet. Such a PSA layer tends to have a good elastic modulus as well as excellent removability. Specific examples of the isobutylene-based polymer include polyisobutylene and isobutylene-isoprene copolymer (butyl rubber).

The starting monomer mixture to form the polymer A disclosed herein include isobutylene accounting for 50% or more by weight (e.g. more than 50% by weight), preferably 75% or more by weight, more preferably 85% or more by weight, or yet more preferably 90% or more by weight (e.g. 95% by weight or more) thereof. The ratio of isobutylene in the entire starting monomer mixture can be 99% to 100% by weight. The isobutylene-based polymer can be a copolymer in which isobutylene accounts for more than 50% by weight of the monomers, or even 70% by weight or more. Examples of the copolymer include a copolymer of isobutylene and butene (normal butylene), a copolymer (butyl rubber) of isobutylene and isoprene, vulcanized products and modified products of these. Examples of the copolymers include butyl rubbers such as regular butyl rubber, chlorinated butyl rubber, brominated butyl rubber, and partially crosslinked butyl rubber. Examples of the vulcanized and modified products include those modified with functional groups such as hydroxy group, carboxy group, amino group, and epoxy group. The isobutylene-based polymer that can be preferably used from the standpoint of the moisture resistance, reduction of outgassing, and adhesive strength, etc., includes polyisobutylene and isobutylene-isoprene copolymer (butyl rubber). The copolymer can be a copolymer (e.g. an isobutylene-isoprene copolymer) of which the other monomers (isoprene, etc.) excluding isobutylene has a copolymerization ratio lower than 30% by mol.

As used herein, the “polyisobutylene” refers to a polyisobutylene in which the copolymerization ratio of monomers excluding isobutylene is 10% or lower (preferably 5% or lower) by weight. In particular, homo-isobutylene is preferable. As the polymer A, several species of isobutylene-based polymer (typically polyisobutylene) with varied Mw values can be used together.

In addition to isobutylene, the starting monomer mixture to form the polymer A disclosed herein may optionally include one, two or more species of monomers (non-isobutylene monomers) selected among butene, isoprene, butadiene, styrene, ethylene and propylene. The polymer A can be a copolymer obtainable by copolymerizing one, two or more species of the examples of monomers. The starting monomer mixtures for forming the polymer A disclosed herein typically comprises one, two or more species of non-isobutylene monomers at a ratio of 50% or below (e.g. below 50% by weight), preferably about 25% or below, more preferably about 15% or below, or yet more preferably about 10% or below (e.g. about 5% or below). The non-isobutylene monomer content in the entire starting monomer mixture can also be about 1% by weight or less. The polymer A according to a preferable embodiment is a copolymer obtainable by copolymerizing a monomer selected among isoprene and butenes as the non-isobutylene monomer. From the standpoint of reduction of outgassing (especially, reduction of gas formation that may degrade the durability, reliability or accurate operation of electronic devices such as magnetic disc devices), the styrene content in the starting monomer mixture is preferably less than 10% by weight or more preferably less than 1% by weight. The art disclosed herein can be preferably implemented in an embodiment where the starting monomer mixture is essentially free of styrene.

The molecular weight of the polymer A (typically, polyisobutylene) is not particularly limited. For instance, a species having a Mw of about 1×10⁴ or higher can be suitably selected and used. The maximum Mw is not particularly limited and can be about 150×10⁴ or lower. From the standpoint of the moisture resistance, the polymer A according to a preferable embodiment has a Mw of preferably about 100×10⁴ or lower, for instance, about 80×10⁴ or lower. From the standpoint of the PSAs elastic modulus, cohesive strength and so on, the Mw is preferably about 2×10⁴ or higher, more preferably about 3×10⁴ or higher, or yet more preferably about 5×10⁴ or higher (e.g. about 7×10⁴ or higher). From the standpoint of the moisture resistance, the Mw is preferably about 50×10⁴ or lower, more preferably about 30×10⁴ or lower, yet more preferably about 15×10⁴ or lower, or particularly preferably about 10×10⁴ or lower (e.g. below 10×10⁴). The polymer A according to another embodiment may have a Mw of, for instance, about 5×10⁴ or higher, or preferably about 15×10⁴ or higher (typically about 30×10⁴ or higher).

While no particular limitations are imposed, as the polymer A (typically, polyisobutylene), it is preferable to use a species having a dispersity (Mw/Mn) (which is indicated as a ratio of weight average molecular weight (Mw) to number average molecular weight (Mn)) in a range of 3 to 7 (more preferably 3 to 6, e.g. 3.5 to 5.5). For instance, as the polymer A, several species of polyisobutylene varying in Mw/Mn can be used together.

The Mw and Mn values of polymer A here refer to values based on polystyrene that are determined by gel permeation chromatography (GPC) analysis. As the GPC analyzer, for instance, model name HLC-8120 GPC available from Tosoh Corporation can be used. The Mw and Mn of polymer B (e.g. butyl rubber) can also be determined by similar GPC analysis.

### (Polymer B)

In addition to the polymer A, the PSA composition disclosed herein comprises a polymer B different from the polymer A. Just like the aforementioned polymer A, the polymer B is an isobutylene-based polymer in which isobutylene is polymerized at a ratio of at least 50% by weight, but has a monomer composition different from that of the polymer A. In typical, the polymers A and B are different species of polymer.

The polymer B is typically a copolymer in which isobutylene accounts for more than 50% by weight, or even 70% by weight or more of the monomers therein. The starting monomer mixture for forming the polymer B disclosed herein includes about 60% (by weight) isobutylene or more, preferably about 70% by weight or more, more preferably about 80% by weight or more, or yet more preferably about 90% by weight or more (e.g. about 95% by weight or more). The copolymer can be, for instance, a copolymer of isobutylene and butene (normal butylene), a copolymer of isobutylene and isoprene (i.e. butyl rubber), vulcanization or modification products of these, etc. Examples of the copolymer include butyl rubbers such as regular butyl rubber, chlorinated butyl rubber, brominated butyl rubber, and partially-crosslinked butyl rubber. Examples of the vulcanization and modification products include species modified with functional groups such as hydroxy group, carboxy group, amino group and epoxy group. Isobutylene-based polymers that can be preferably used from the standpoint of the moisture resistance, reduction of outgassing, the adhesive strength, etc., include polyisobutylene and isobutylene-isoprene copolymer (butyl rubber). Such a copolymer can be, for instance, a copolymer (e.g. isobutylene-isoprene copolymer) in which non-isobutylene monomers (isoprene, etc.) has a copolymerization ratio below 30% by mol.

In a preferable embodiment, the polymer B is a polymer in which isobutylene and isoprene are copolymerized, typically an isobutylene-isoprene copolymer (butyl rubber). In the copolymer, the combined amount of isobutylene and isoprene as monomers accounts for typically at least 50% (e.g. at least 70%, preferably at least 80%, or yet more preferably at least 90%) by weight of the entire monomers. In a particularly preferable embodiment, the combined amount of isobutylene and isoprene as monomers accounts for about 95% by weight or more (e.g. 99% to 100% by weight) of all monomers.

In addition to isobutylene, the starting monomer mixture for forming the polymer B disclosed herein may include one, two or more species of monomers (non-isobutylene monomers) optionally selected among butene, isoprene, butadiene, styrene, ethylene and propylene. The polymer B can be a copolymer obtainable by copolymerizing one, two or more species of the exemplified monomers. The starting monomer mixture for forming the polymer B disclosed herein typically includes one, two or more species of non-isobutylene monomers at a ratio of 50% by weight or below (e.g. below 50% by weight). The non-isobutylene monomer content can be, for instance, about 25% by weight or less, about 15% by weight or less, or even about 10% by weight or less (e.g. about 5% by weight or less).

In an embodiment using a butyl rubber as the polymer B, the ratio of isoprene as a monomer of the polymer B is below 50% by weight, for instance, suitably about 40% by weight or below, preferably about 30% by weight or below, more preferably about 20% by weight or below, or yet more preferably about 10% by weight or below (e.g. about 5% by weight or below).

From the standpoint of reduction of outgassing (especially, reduction of gas formation that may degrade the durability, reliability or accurate operation of electronic devices such as magnetic disc devices), the styrene content in the monomers is preferably below 10% by weight, or more preferably below 1% by weight. The art disclosed herein can be preferably implemented in an embodiment where the starting monomer mixture is essentially free of styrene.

The molecular weight of the polymer B (e.g. butyl rubber) is not particularly limited. For instance, a species having a Mw in a range between 5×10⁴ and 100×10⁴ can be suitably selected and used. In view of the balance between the ease of forming the PSA layer and tight adhesion (adhesive strength) to adherend, the butyl rubber has a Mw of preferably 10×10⁴ or higher, more preferably 15×10⁴ or higher, or yet more preferably about 30×10⁴ or higher (e.g. 50×10⁴ or higher); and suitably about 150×10⁴ or lower, preferably 100×10⁴ or lower, more preferably 80×10⁴ or lower, or yet more preferably about 70×10⁴ or lower (e.g. about 60×10⁴ or lower). Several species of butyl rubber varying in Mw can be used together.

While no particular limitations are imposed, the butyl rubber has a dispersity (Mw/Mn) in a range between 3 and 8 or more preferably in a range between 4 and 7. When using butyl rubber as the polymer B, several species of butyl rubber varying in Mw/Mn can be used together.

The Mooney viscosity of the butyl rubber is not particularly limited. For instance, a butyl rubber having a Mooney viscosity ML₁₊₈(125° C.) between 10 and 100 can be used. In view of the balance between the PSA layer's ease of formation and tightness of bonding to adherend (adhesive strength), a butyl rubber having a Mooney viscosity ML₁₊₈(125° C.) of 15 to 80 (more preferably 30 to 70, e.g. 40 to 60) is preferable.

In the embodiment using polymers A and B together, because they vary in molecular weight, it is possible to preferably bring about moisture resistance based on the lower molecular polymer as well as adhesive properties (cohesive strength, etc.) based on the higher molecular weight polymer. From such a standpoint, in an embodiment in which the polymer A has a relatively higher molecular weight, the ratio (M_{A}/M_{B}) of polymer A's Mw (M_{A}) to polymer B's Mw (M_{B}) is higher than 1, preferably about 2 or higher, more preferably about 3 or higher, or yet more preferably about 5 or higher (e.g. about 7 or higher). The maximum M_{A}/M_{B} ratio value is suitably about 100 or lower, preferably about 50 or lower, more preferably about 20 or lower, or yet more preferably about 10 or lower (e.g. lower than 10). In an embodiment in which the polymer B has a relatively higher molecular weight, the ratio (M_{B}/M_{A}) of polymer B's Mw (M_{B}) to polymer A's Mw (M_{A}) is higher than 1, preferably about 2 or higher, more preferably about 3 or higher, or yet more preferably about 5 or higher (e.g. about 7 or higher). The maximum M_{B}/M_{A} ratio value is suitably about 100 or lower, preferably about 50 or lower, more preferably about 20 or lower, or yet more preferably about 10 or lower (e.g. lower than 10).

The blend ratio of A to B can be suitably selected so as to obtain preferable elastic modulus, moisture resistance and adhesive properties disclosed herein. The weight ratio (C_{A}/C_{B}) of polymer A content (C_{A}) to polymer B content (C_{B}) can be, for instance, 95/5 to 5/95, preferably 90/10 to 10/90, more preferably 80/20 to 20/80, yet more preferably 70/30 to 30/70, or particularly preferably 60/40 to 40/60 (typically 55/45 to 45/55).

In a preferable embodiment, the dispersity (Mw/Mn) of the polymers at large in the PSA composition is 3 or higher, or more preferably 4 or higher. According to the PSA comprising such polymers, adhesive strength can be easily combined with resistance to leftover adhesive residue. It also brings the PSA layer's elastic modulus in a favorable range and good moisture resistance tends to be obtained. At or above a certain Mw/Mn value, the PSA can be obtained with a low solution viscosity for its Mw. The dispersity of the polymers at large can also be 5 or higher, 6 or higher, or even 7 or higher. The maximum dispersity of the polymers at large is not particularly limited; it is preferably 10 or lower (e.g. 8 or lower).

The combined ratio of polymers A and B in the solid content (possibly a PSA layer) of the PSA composition disclosed herein is not particularly limited. It is usually about 50% by weight or higher, or suitably about 80% by weight or higher. In a preferable embodiment, the combined ratio of polymers A and B is about 90% by weight or higher, more preferably about 95% by weight or higher, or yet more preferably about 97% by weight or higher (e.g. 99% to 100% by weight). The solid content of the PSA composition and a PSA layer formed from the PSA composition may essentially consist of polymers A and B.

The art disclosed herein can be preferably implemented in an embodiment having a PSA layer formed of a PSA (a non-crosslinked PSA) in which the polymers are not crosslinked. Here, the term “PSA layer formed of a non-crosslinked PSA” refers to a PSA layer that has not been subjected to an intentional treatment (i.e. crosslinking treatment, e.g. addition of a crosslinking agent, etc.) for forming chemical bonds among the polymers.

### (Other Additives)

The PSA composition may comprise, as necessary, various additives generally used in the PSA field, such as tackifier (tackifier resin), leveling agent, crosslinking accelerator, plasticizer, fillers, colorants including pigments and dyes, softening agent, anti-static agent, anti-aging agent, UV-absorbing agent, antioxidant and photo-stabilizing agent. Optionally, a third polymer that is neither polymer A nor B may be included as well. With respect to these various additives, heretofore known species can be used by typical methods. From the standpoint of avoiding the use of a low-molecular-weight component which may be susceptible to outgassing, the other additive content (e.g. tackifier resin, anti-aging agent, UV absorber, antioxidant, photo-stabilizer) in the PSA composition is preferably limited to or below about 10% by weight (e.g. to or below 5% by weight, typically to or below 3% by weight). The art disclosed herein can be preferably implemented in an embodiment where the PSA composition is essentially free of other additives (e.g. tackifier resin, anti-aging agent, UV absorber, antioxidant, photo-stabilizer).

The form of the PSA composition is not particularly limited. For instance, it can be in various forms, such as a PSA composition (a solvent-based PSA composition) that comprises PSA-layer-forming materials as described above in an organic solvent, a PSA composition (water-dispersed PSA composition, typically an aqueous emulsion-based PSA composition) in which the PSA is dispersed in an aqueous solvent, a PSA composition that is curable by an active energy ray (e.g. UV ray), and a hot-melt PSA composition. From the standpoint of the ease of application and the adhesive properties, a solvent-based PSA composition can be preferably used. As the solvent, it is possible to use one species of solvent or a mixture of two or more species, selected among aromatic compounds (typically aromatic hydrocarbons) such as toluene and xylene; acetic acid esters such as ethyl acetate and butyl acetate; and aliphatic or alicyclic hydrocarbons such as hexane, cyclohexane, heptane and methyl cyclohexane. While no particular limitations are imposed, it is usually suitable to adjust the solvent-based PSA composition to include 5% to 30% non-volatiles (NV) by weight. Too low an NV tends to result in higher production costs while too high an NV may degrade the handling properties such as the ease of application.

### <PSA Layer>

The PSA layer in the art disclosed herein can be formed using the PSA composition in accordance with a known method for forming PSA layers in PSA sheets. For instance, it is preferable to employ a direct method where the PSA composition with PSA layer-forming materials as described above dissolved or dispersed in a suitable solvent is directly provided (typically applied) to a substrate and allowed to dry to form a PSA layer. Alternatively, it is also possible to employ a transfer method where the PSA composition is provided to a releasable surface (e.g. a surface of a release liner, a substrate's backside treated with release agent, etc.) and allowed to dry to form a PSA layer on the surface, and the PSA layer is transferred to a non-releasable substrate. As the release face, a surface of a release liner, a substrate's back face that has been treated with release agent, and the like can be used. The PSA layer disclosed herein is typically formed in a continuous manner.

The PSA composition can be applied, for instance, with a known or commonly used coater such as gravure roll coater, reverse roll water, kiss roll water, dip roll coater, bar coater, knife coater, and spray water.

In the art disclosed herein, the thickness of the PSA layer forming the adhesive face is not particularly limited. The PSA layer has a thickness of suitably 3 am or greater, preferably 10 am or greater, or more preferably 20 am or greater. With increasing thickness of the PSA layer, the adhesive strength to adherend tends to increase. Having at least a certain thickness, the PSA layer absorbs the adherend's surface roughness to form tight adhesion. When the PSA layer has a thickness of 10 μm or greater, for instance, it can provide good, tight adhesion to an adherend having a surface whose arithmetic mean surface roughness Ra is about 1 μm to 5 μm (e.g. 3 μm). The thickness of the PSA layer forming the adhesive face can be, for instance, 150 μm or less; it is suitably 100 μm or less, or preferably 50 μm or less. With decreasing thickness of the PSA layer, it tends to show a greater ability to inhibit water vapor from laterally permeating the PSA layer, leading to reduction of outgassing from the PSA layer. A smaller thickness of the PSA layer is also advantageous from the standpoint of reducing the thickness and weight of the PSA sheet.

The storage modulus at 25° C., G′(25° C.), of the PSA layer disclosed herein is not particularly limited and it can be set in a suitable range according to required properties, etc. In a preferable embodiment, the G′(25° C.) is less than 0.5 MPa. The PSA layer whose G′(25° C.) is at or below a prescribed value wets the adherend surface well to form tight adhesion. The G′(25° C.) is more preferably 0.4 MPa or less, or yet more preferably 0.3 MPa or less (e.g. 0.25 MPa or less). The G′(25° C.) can also be, for instance, 0.2 MPa or less. The G′(25° C.) value is not particularly limited and is suitably greater than about 0.01 MPa. From the standpoint of the adhesive properties, prevention of leftover adhesive residue, etc., it is preferably 0.05 MPa or greater, or more preferably 0.07 MPa or greater (e.g. 0.1 MPa or greater). In a particularly preferable embodiment, the PSA layer has a storage modulus G′(25° C.) of 0.09 MPa or greater (e.g. 0.16 MPa or greater) and 0.29 MPa or less (e.g. 0.24 MPa or less). When the PSA layer has a storage modulus G′(25° C.) in these ranges, excellent moisture resistance can be obtained.

In the art disclosed herein, the storage modulus G′(25° C.) of a PSA layer can be determined by dynamic elastic modulus measurement. In particular, several layers of the PSA subject to measurement are layered to fabricate an approximately 2 mm thick PSA layer. A specimen obtained by punching out a disc of 7.9 mm diameter from the PSA layer is fixed between parallel plates. With a rheometer (e.g. ARES available from TA Instruments or a comparable system), dynamic elastic modulus measurement is carried out to determine storage modulus G′(25° C.). The PSA layer subject to measurement can be formed by applying a layer the corresponding PSA composition on a release face of a release liner or the like and allowing it to dry or cure. The thickness (coating thickness) of the PSA layer subjected to the measurement is not particularly limited as long as it is 2 mm or less. It can be, for instance, about 50 μm.
Measurement mode: shear mode
Temperature range: −50° C. to 150° C.
Heating rate: 5° C./min
Measurement frequency: 1 Hz

The same measurement method is also used in the working examples described later.

### <Substrate Layer>

The PSA sheet disclosed herein may typically has a substrate layer. There are no particular limitations to the substrate layer-forming material that can be used in the art disclosed herein. As the substrate layer, in accordance with the purpose of the PSA sheet, a suitable species can be selected and used among, for instance, plastic film such as polypropylene film, ethylene-propylene copolymer film, polyester film and polyvinyl chloride film; a sheet formed of foam such as polyurethane foam, polyethylene foam and polychloroprene foam; woven fabrics and nonwoven fabrics (including paper such as Japanese paper and high-grade paper) of pure or blended yarn of various fibrous materials (possibly natural fibers such as hemp and cotton, synthetic fibers such as polyester and vinylon, semi-synthetic fibers such as acetate, etc.); and metal foil such as aluminum foil and copper foil.

The substrate layer according to a preferable embodiment is a moisture-impermeable layer. As used herein, the moisture-impermeable layer refers to a layer (film) that has a moisture permeability (a water vapor transmission rate in the thickness direction) of less than 5×10⁻¹ g/m²·24 h when determined at 40° C. at 90% RH based on the MOCON method (JIS K7129:2008). With the use of the moisture-impermeable layer satisfying this property, it is possible to obtain a PSA sheet having moisture resistance in the thickness direction. The moisture permeability is preferably less than 5×10⁻² g/m²·24 h, or more preferably less than 5×10⁻³ g/m²·24 h, for instance, less than 5×10⁻⁵ g/m²·24 h. As the moisture permeability measurement device, PERMATRAN-W3/33 available from MOCON, Inc. or a comparable product can be used.

In a preferable embodiment, the substrate layer disclosed herein includes an inorganic layer. The material or structure of the inorganic layer is not particularly limited and can be selected in accordance of the purpose and usage. From the standpoint of the moisture resistance and airtight properties, it is advantageous that the inorganic layer is essentially non-porous. In typical, a preferable inorganic layer is essentially formed of an inorganic material. For instance, an inorganic layer formed of at least 95% (by weight) inorganic material is preferable (more preferably at least 98% by weight, or yet more preferably at least 99% by weight). The number of inorganic layers in the substrate layer is not particularly limited; it can be one, two or more (e.g. about two to five). From the standpoint of the ease of manufacturing and availability, the number of inorganic layers in the substrate layer is preferably about 1 to 3, or more preferably one or two. When the substrate layer includes several inorganic layers, the materials and structures (thicknesses, etc.) of these inorganic layers can be the same with or different from one another.

As the inorganic material forming the inorganic layer, it is possible to use, for instance, metal materials including elemental metals such as aluminum, copper, silver, iron, tin, nickel, cobalt, and chromium as well as alloys of these; and inorganic compounds such as oxides, nitrides and fluorides of metals and metalloids including silicon, aluminum, titanium, zirconium, tin and magnesium. Specific examples of the inorganic compounds include silicon oxides (SiOₓ, typically SiO₂), aluminum oxide (Al₂O₃), silicon nitride (Si₃N₄), silicon oxide nitride (SiOₓN_{y}), titanium oxide (TiO₂), and indium tin oxide (ITO).

The metal materials can be used as the inorganic layers as metal foils (e.g. aluminum foil) formed by a known method such as rolling by a rolling mill, etc. Alternatively, for instance, a metal material formed in a layer by a known film-forming method such as vacuum vapor deposition, spattering and plating.

The inorganic compound can be typically used as the inorganic layer in a form of thin film formed by a known method. As the method for forming thin film of the inorganic compound, various vapor deposition methods can be used. For instance, physical vapor deposition methods (PVD) such as vacuum vapor deposition, spattering and ion plating, chemical vapor deposition methods (CVD) and like method can be used. The substrate layer may further have a resin layer on top of the vapor deposition layer. For instance, the resin layer may be a topcoat layer provided for purposes such as protecting the vapor deposition layer.

From the standpoint of the moisture resistance, ease of manufacturing, availability, etc., it is preferable to use an inorganic layer formed of, for instance, aluminum or an aluminum alloy. From the standpoint of the moisture resistance, ease of manufacturing, availability, etc., as the inorganic layer formed of an inorganic compound, for instance, a silicon oxide layer or an aluminum oxide layer can be preferably used. Examples of an inorganic layer preferable for being able to form a highly transparent inorganic layer include a silicon oxide layer, an aluminum oxide layer and an ITO layer.

The maximum thickness of the inorganic layer is not particularly limited. From the standpoint of obtaining conformability to shapes of adherends, the inorganic layer advantageously has a thickness of 50 μm or less. From the standpoint of reducing the thickness and weight of the PSA sheet, the thickness of the inorganic layer is suitably 15 am or less, preferably 13 am or less, more preferably 11 am or less, or yet more preferably 9 μm or less. When the substrate layer includes several inorganic layers, the combined thickness of these inorganic layers is in these ranges. The minimum thickness of the inorganic layer is not particularly limited and can be suitably selected so as to obtain a PSA sheet that shows moisture resistance suited for the purpose and usage. The thickness of the inorganic layer is suitably 1 nm or greater. From the standpoint of the moisture resistance, air-tight properties, etc., it is preferably 2 nm or greater, or more preferably 5 nm or greater. When the substrate layer includes several inorganic layers, it is preferable that at least one of them has a thickness in these ranges. Each of the several inorganic layers may have a thickness in these ranges as well.

The preferable thickness range of the inorganic layer may also vary depending on the material of the inorganic layer, the formation method, etc. For instance, when metal foil (e.g. aluminum foil) forms the inorganic layer (or the metal layer), in view of the moisture resistance, ease of manufacturing, crease resistance, etc., its thickness is suitably 1 am or greater, preferably 2 am or greater, or more preferably 5 μm or greater. In view of the flexibility which leads to adherend conformability, the metal layer's thickness is suitably 50 μm or less, preferably 20 am or less, more preferably 15 am or less, yet more preferably 12 μm or less, or particularly preferably 10 μm or less. With respect to the inorganic layer formed by vapor deposition of an inorganic compound, in view of the balance between flexibility and ease of manufacturing the substrate layer, its thickness is suitably in a range between 1 nm and 1000 nm, preferably in a range between 2 nm and 300 nm, or more preferably in a range between 5 nm and less than 100 nm.

The substrate layer disclosed herein may include a resin layer in addition to the inorganic layer. The resin layer may serve as a protection layer to prevent the inorganic layer from getting damaged by bending deformation and friction. Thus, the substrate layer including the resin layer in addition to the inorganic layer is preferable from the standpoint of the endurance and reliability of moisture-resistant properties and also from the standpoint of the ease of handling the substrate layer or the PSA sheet. By placing the resin layer on the PSA layer side surface of the substrate layer, the anchoring of the PSA layer can be enhanced. When the inorganic layer is formed by vapor deposition, spattering or like method, the resin layer can be used as the base for forming the inorganic layer.

The structure of the resin layer is not particularly limited. For instance, the resin layer may include a void space as in fiber assemblies such as woven fabrics and nonwoven fabrics or as in foam bodies such as polyethylene foam; or it can be a resin layer (resin film) essentially free of a void space. From the standpoint of reducing the thickness of the PSA sheet, it is preferable use a resin layer essentially free of a void space.

As the resin material forming the resin layer, it is possible to use, for instance, polyester resins such as polyethylene terephthalate (PET), polybutylene terephthalate (PBT) and polyethylene naphthalate (PEN); polyolefin resins such as polyethylene (PE) and polypropylene (PP); polyimide (PI); polyetheretherketone (PEEK); chlorine-containing polymers such as polyvinyl chloride (PVC) and polyvinylidene chloride; polyamide-based resins such as nylon and aramid; polyurethane resin; polystyrene-based resin; acrylic resins; fluororesins; cellulose-based resins; and polycarbonate-based resins. Of these, solely one species or a combination of two or more species can be used. When two or more species of resin are used together, these resins can be used blended or separately. Both thermoplastic resins and thermosetting resins can be used. From the standpoint of the ease of forming film, etc., a thermoplastic resin is preferably used.

In the substrate layer including a resin layer, at an edge face of the PSA sheet, water vapor may enter the resin layer from its side (lateral surface). From the standpoint of inhibiting such entrance of water vapor, as the resin material forming the resin layer, a highly moisture-resistant material can be preferably used. For instance, a preferable resin layer is formed, using a resin material whose primary component is a polyester resin such as PET or a polyolefinic resin such as PE and PP. In a preferable embodiment, PET film can be preferably used as the resin layer. In another preferable embodiment, as the resin layer, it is preferable to use BOPP (biaxially oriented polypropylene) film obtainable by forming film of a resin material that comprises PP as the primary component and biaxially stretching the film. In the PSA sheet having no inorganic layer further on the adherend side relative to the resin layer, it is particularly significant to inhibit entrance of water vapor from the lateral surface of the resin layer. A typical example of the PSA sheet having such a constitution is a PSA sheet in which the PSA layer-side surface of the substrate layer is formed with a resin layer.

The resin layer may include, as necessary, various additives such as fillers (inorganic fillers, organic fillers, etc.), anti-aging agent, antioxidant, UV absorber, anti-static agent, slip agent and plasticizer. The ratio of the various additives included is below about 30% by weight (e.g. below 20% by weight, typically below 10% by weight).

The number of resin layers in the substrate layer is not particularly limited and it can be one, two or more (e.g. about two to five). From the standpoint of the ease of manufacturing and availability, the number of resin layers in the substrate layer is preferably one to three, or more preferably one or two. When the substrate layer includes several resin layers, the materials and structures (thicknesses, inclusion of a void space, etc.) of these resin layers can be the same with or different from one another.

The method for forming the resin layer is not particularly limited. A heretofore known general resin film molding method can be suitably employed to form the resin layer, for instance, extrusion molding, inflation molding, T-die casting, calender roll molding and wet casting. The resin layer may a non-stretched kind or may be subjected to a stretching process such as uni-axial stretching and bi-axial stretching.

The minimum thickness of the resin layer is not particularly limited. From the standpoint of the crease resistance, ease of forming film, etc., the thickness of the resin layer is suitably 1 μm or greater, preferably 3 μm or greater, more preferably 5 μm or greater, or yet more preferably 7 μm or greater. When the substrate layer includes several resin layers, it is preferable that at least one of them has a thickness in these ranges. Each of the several resin layers may have a thickness in these ranges as well.

The maximum thickness of the resin layer is not particularly limited. For instance, it can be 100 μm or less. From the standpoint of reducing the thickness and weight of the PSA sheet, the thickness of the resin layer is suitably 70 μm or less, preferably 55 μm or less, or more preferably 35 μm or less. When the substrate layer includes several resin layers, the combined thickness of these resin layers is preferably in these ranges. In general, the moisture permeability of the resin layer is higher than that of the inorganic layer. Thus, it is also preferable to make the combined thickness of resin layers smaller from the standpoint of preventing water vapor from entering the resin layer from its lateral surface.

The inorganic layer and the resin layer are preferably bonded. The bonding method is not particularly limited. A method known in the pertinent field can be suitably employed. For instance, it is possible to employ a method (extrusion lamination) where a resin material for forming the resin layer is melted and extruded along with a pre-molded inorganic layer (typically metal foil), a method where a solution or dispersion of the resin material for forming the resin layer is applied to a pre-molded inorganic layer and allowed to dry, and like method. Alternatively, it is also possible to employ a method where an inorganic layer is vapor-deposited on a pre-molded resin layer, a method where an inorganic layer is bonded to a separately-molded resin layer, and like method. For instance, the bonding can be achieved by hot pressing. The resin layer and the inorganic layer can be bonded via an adhesive layer or a PSA layer.

The adhesive layer to bond the resin layer and the inorganic layer can be an undercoat layer formed by applying an undercoat such as primer to the resin layer. As the undercoat, those known in the pertinent field can be used, such as urethane-based undercoat, ester-based undercoat, acrylic undercoat, and isocyanate-based undercoat. From the standpoint of reducing the thickness and weight of the PSA sheet, the thickness of the undercoat layer is suitably 7 μm or less, preferably 5 μm or less, or more preferably 3 μm or less. The minimum thickness of the undercoat layer is not particularly limited. For instance, it can be 0.01 μm or greater (typically 0.1 μm or greater).

Before the bonding process, the resin layer may be subjected to common surface treatment, chemical or physical treatment, for instance, mattifying treatment, corona discharge treatment, crosslinking treatment, chromic acid treatment, ozone exposure, flame exposure, high-voltage electric shock exposure, and ionized radiation treatment.

The PSA layer(s) placed between layers forming the substrate layer to bond them together are not exposed to the surface of the PSA sheet; and therefore, they do not correspond to the PSA layer forming the adhesive face of the PSA sheet. In the PSA sheet disclosed herein, the material and physical properties of such a PSA layer for internal use in the substrate layer are not particularly limited. The PSA layer can be formed of a PSA similar to the PSA layer forming the adhesive face or can be formed of a different PSA. It is not particularly limited in thickness, either. For instance, it may have a comparable thickness to the undercoat layer.

Favorable examples of the substrate layer used in the PSA sheet disclosed herein include a substrate layer formed of a laminate body that comprises an inorganic layer as well as first and second resin layers laminated on top and bottom of the inorganic layer. The first and second resin layers forming the substrate layer are laminated on top and bottom of the inorganic layer. As long as such a layer order can be obtained, the first and second resin layers may be in direct contact with the inorganic layer or they may be placed via undercoat layers as described above to obtain tight adhesion between themselves and the inorganic layer. In the PSA sheet disclosed herein, the first resin layer refers to the resin layer placed on the backside (the front face of the substrate layer) of the PSA sheet relative to the inorganic layer and the second resin layer refers to the resin layer placed on the PSA layer side.

The inorganic layer can be a metal layer formed of an aforementioned metal material. For instance, an aluminum layer is preferable. The first and second resin layers are preferably formed from the same material. For instance, thermoplastic resins exemplified above can be used. Of these materials, solely one species or a combination of two or more species can be used. Each of the first and second resin layers may have a layered structure with two or more layers, but is preferably a monolayer. In particular, preferable materials forming the first and second resin layers include PET, PP and polystyrene. PET and PP are more preferable.

The first and second resin layers have thicknesses T_{R1} and T_{R2}, respectively; and their ratio (T_{R1}/T_{R2}) is not particularly limited, but is suitably 0.5 or greater, preferably 1 or greater, more preferably 1.5 or greater, or yet more preferably 2.0 or greater. The T_{R1}/T_{R2} ratio is suitably about 10 or less, preferably 7.0 or less, more preferably 5.0 or less, or yet more preferably 4.0 or less. When the T_{R1}/T_{R2} ratio is in these ranges, adherend conformability and crease resistance can be preferably combined. The thickness T_{R1} of the first resin layer is suitably about 10 μm or greater, preferably 15 μm or greater, more preferably 18 μm or greater, or yet more preferably 20 μm or greater (e.g. 22 μm or greater). T_{R1} is suitably about 100 μm or less, preferably 70 μm or less, more preferably 60 μm or less, yet more preferably 50 μm or less, or particularly preferably 35 μm or less. The thickness T_{R2} of the second resin layer is suitably about 1 μm or greater, preferably 3 μm or greater, more preferably 5 μm or greater, or yet more preferably 7 μm or greater. T_{R2} is suitably about 25 μm or less, preferably 20 μm or less, more preferably 15 μm or less, or yet more preferably 12 μm or less (e.g. 10 μm or less).

The inorganic layer has a thickness T_{I} and the first and second resin layers have a combined thickness T_{R} (=T_{R1}+T_{R2}); and their ratio (T_{R}/T_{I}) is not particularly limited. From the standpoint of preventing creases, protecting the inorganic layer, etc., the ratio is suitably 1 or greater, preferably 2 or greater, more preferably 3 or greater, or yet more preferably 4 or greater. When it is bent and applied to accommodate the adherend shape, in view of the adherend conformability, the T_{R}/T_{I} ratio is suitably 10 or less, preferably 8 or less, or more preferably 6 or less. The total (T_{R}) of the first and second resin layers' thicknesses T_{R1} and T_{R2} is suitably about 15 μm or greater, preferably 20 μm or greater, more preferably 25 μm or greater, or yet more preferably 30 μm or greater. T_{R} is suitably about 100 μm or less, preferably 80 μm or less, more preferably 70 μm or less, or yet more preferably 60 μm or less (e.g. 50 μm or less). The substrate layer in this embodiment can effectively protect the inorganic layer (e.g. an aluminum layer) as thin film from bending, creasing, breaking, etc. By this, even when the PSA sheet is exposed to various stressors in the manufacturing process, etc., or even when it is exposed to a harsh environment for a long period while in use, it can securely maintain the properties as the moisture-resistant film.

As the method for forming a laminate body having the inorganic layer, first resin layer and second resin layer, it is possible to employ various methods as described earlier, such as a method where the respective layers are formed as films by a known method and they are laminated dry by forming undercoat layers described above, a method where the inorganic layer is formed on the first resin layer in a tightly bonded manner and the second resin layer is laminated dry or extrusion-laminated on top of it, and like method.

The minimum thickness of the substrate layer is not particularly limited. From the standpoint of the ease of manufacturing and handling the PSA sheet, the thickness of the substrate layer is about 3 μm or greater, or suitably about 5 μm or greater (e.g. 10 μm or greater). To obtain moisture resistance and rigidity unsusceptible to creasing, it is desirable that the substrate layer is thick. From such a standpoint, the thickness of the substrate layer is preferably 15 μm or greater, more preferably 20 μm or greater, yet more preferably 30 μm or greater, or particularly preferably 40 μm or greater. The maximum thickness of the substrate layer is not particularly limited, either. It is about 1 mm or less, or suitably about 300 μm or less (e.g. 150 μm or less). From the standpoint of the adherend conformability of the PSA sheet and of reducing its thickness and weight, the thickness of the substrate layer is preferably 100 μm or less, more preferably 80 μm or less, yet more preferably 70 μm or less, or particularly preferably 65 μm or less (e.g. 55 μm or less). The substrate layer with such a limited thickness is less likely to lead to formation of a space between the adherend and the PSA sheet; and therefore, it can prevent water vapor permeation through the space.

The PSA layer side surface of the substrate layer may be subjected to common surface treatment, chemical or physical treatment, for instance, mattifying treatment, corona discharge treatment, crosslinking treatment, chromic acid treatment, ozone exposure, flame exposure, high-voltage electric shock exposure, and ionized radiation treatment. On the PSA layer-side surface of the substrate layer, an undercoat layer may be placed, which is formed by applying an undercoat such as primer to the resin layer. As the undercoat, those known in the pertinent field can be used, such as urethane-based, ester-based, acrylic, and isocyanate-based kinds. From the standpoint of reducing the thickness and weight of the PSA sheet, the thickness of the undercoat layer is suitably 7 μm or less, preferably 5 μm or less, or more preferably 3 μm or less.

### <Release Liner>

In the art disclosed herein, a release liner can be used during formation of the PSA layer; fabrication of the PSA sheet; storage, distribution and shape machining of the PSA sheet prior to use, etc. The release liner is not particularly limited. For example, a release liner having a release layer on the surface of a liner substrate such as resin film and paper; a release liner formed from a low adhesive material such as a fluoropolymer (polytetrafluoroethylene, etc.) or a polyolefinic resin (PE, PP, etc.); or the like can be used. The release layer can be formed, for instance, by subjecting the liner substrate to a surface treatment with a release agent such as a silicone-based, long-chain alkyl-based, fluorine-based, or molybdenum disulfide-based release agent. When the PSA sheet is used as a sealing material for a magnetic disc device, it is preferable to use a non-silicone-based release liner free of a silicone-based release agent which may produce siloxane gas.

### <Properties of PSA Sheet>

While no particular limitations are imposed, the PSA sheet disclosed herein has a moisture permeability below 90 μg/cm² in in-plane direction of bonding interface of PSA sheet, determined at a permeation distance of 2.5 mm over a 24-hour period based on the MOCON method (equal-pressure method). This limits moisture permeation in in-plane directions of bonding interface (vertical to the thickness direction of the PSA sheet) and excellent moisture resistance tends to be obtained. The moisture permeability in in-plane direction of bonding interface is preferably below 60 μg/cm², more preferably below 30 μm/cm², or yet more preferably below 15 μg/cm² (e.g. below 9 μg/cm²).

In particular, the moisture permeability in in-plane direction of bonding interface is determined by the method described below.

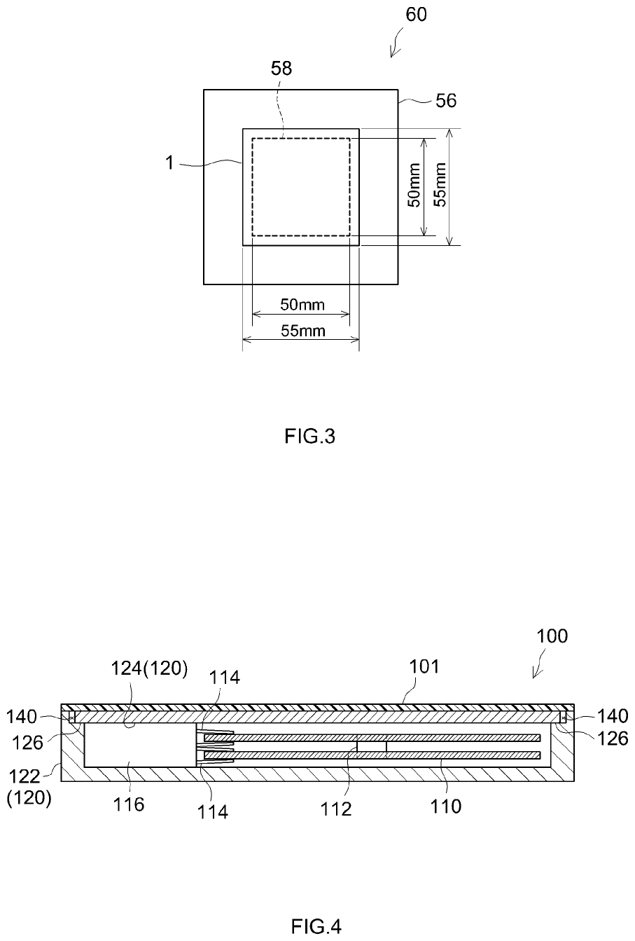

(1) A metal plate having a 50 mm square opening at the center is obtained. FIG. 2 outlines a moisture permeability measurement device 50 used for determining the moisture permeability. In FIG. 2, reference number 56 shows the metal plate and reference number 58 shows the opening made in metal plate 56. FIG. 3 shows a top view of metal plate 56 having opening 58.
(2) The PSA sheet subject to measurement is cut to a 55 mm square and applied to cover the opening in the metal plate to prepare a measurement sample. The PSA sheet is applied to the metal plate to have a bonding width of 2.5 mm at each side of the opening. The PSA sheet is applied at a temperature of 23±2° C. and RH 50±10% by rolling a 2 kg roller back and forth once. The bonding width of the PSA sheet at each side of the opening is the width of the band of bonding interface between the PSA sheet and the metal plate, which is the permeation distance (mm) in an in-plane direction of bonding interface of the PSA sheet. The peripheral length of the opening in the metal plate is referred to as the bonding length (mm) The bonding length (mm) is the total length of the band of bonding interface exposed to water vapor. In particular, the measurement sample has a structure shown by reference number 60, formed of metal plate 56 and PSA sheet 1 applied to metal plate 56 as shown in FIG. 3.
(3) Based on Method B of JIS K 7129:2008, the measurement sample is placed between a dry chamber and a wet chamber in the moisture permeability measurement device. In particular, as shown in FIG. 2, a measurement sample 60 is positioned between a dry chamber 54 and a wet chamber 52. In FIG. 2, WV represents water vapor.
(4) Based on the MOCON method (equal-pressure method), conditioning is carried out for 3 hours. Subsequently, as shown in FIG. 2, at 40° C. and 90% RH (relative humidity), the amount (μg) of moisture that has permeated in an in-plane direction of bonding interface of PSA sheet per one hour is determined.
(5) To obtain the moisture permeability (μg/cm²) in in-plane direction of bonding interface, the amount of moisture permeation per 24 hours converted from the measurement value and the PSA layer's surface area (permeation distance×bonding length) are substituted into the equation:

Moisture permeability (μg/cm²)=amount of moisture permeation (μg)/(permeation distance (cm)×bonding length (cm))

As used herein, the “moisture permeability below 90 μg/cm² in in-plane direction of bonding interface of PSA sheet, determined at a permeation distance of 2.5 mm over a 24-hour period based on the MOCON method (equal-pressure method)” (or the “moisture permeability (μg/cm²) per 24-hour measurement period in in-plane direction of bonding interface of PSA sheet determined based on a modified MOCON method, at a permeation distance of 2.5 mm”) can be a value obtained by a measurement over a 24-hour period, but it is not limited to this; as described above, it can be a 24-hour value converted from a measurement taken for a certain time period (e.g. one hour). The measurement time can be longer than one hour (preferably about 6 hours; the same applies to working examples described later) and the value per 24 hours converted from this measurement value can be used as well.

The kind of metal plate is not particularly limited. For instance, an aluminum plate can be used. The size of the metal plate is not particularly limited, either. In accordance with the size of testing device, etc., for instance, a 100 mm square plate can be used. It is suitable to use a metal plate having a smooth surface, for instance, one having a mean arithmetic roughness Ra of about 3 μm or less. In particular, an aluminum A1050 plate (0.3 mm thick, surface roughness: mirror finished, Ra 0.1 μm) is used. As the testing device, product name PERMATRAN-W3/34G available from MOCON, Inc. or a comparable product can be used. In a testing device of this type, N₂ gas at 90% RH can be supplied to the wet chamber and N₂ gas at 0% RH can be supplied to the dry chamber. This maintains the two chambers divided by the measurement sample at an equal pressure. For the measurement, the gas flow is set at 10 mL/min. In the testing device, the water vapor concentration is measured by an infrared sensor (indicated as “IR” in FIG. 8), but the means of detection is not limited to this. The position of the measurement sample in the testing device is not particularly limited. The adhesive face of the PSA sheet can be placed either on the wet chamber side or on the dry chamber side. The same measurement method is employed in the working examples described later. The measurement value of moisture permeation is used as the amount (μg) of moisture permeated upon zero-point correction based on the measurement value of an aluminum plate with no opening. The same measurement method is employed in the working examples described later.

The measurement method has been created by the present inventors. This method enables previously impossible, highly precise quantification of moisture permeation in in-plane direction of bonding interface. More specifically, differences in moisture permeability in in-plane direction of bonding interface can be detected as significant differences among different samples that have shown similar values in quantification of moisture permeation by conventional cup methods. By employing this method, moisture resistance can be tested at a higher level. For instance, it enables quantification of water vapor permeation that is in a minute amount, yet still capable of affecting HAMR.

While no particular limitations are imposed, the PSA sheet disclosed herein preferably has an amount of thermally released gas of 10 μg/cm² or less (in particular, 0 to 10 μg/cm²) when determined at 130° C. for 30 minutes by GC-MS. The PSA sheet with such highly-limited thermal gas release can be preferably used in an application (typically a magnetic disc device) for which the presence of volatile gas is undesirable. When the PSA sheet satisfying this property is used as a sealing material for a magnetic disc device, it can highly inhibit internal contamination with siloxane and other gas that affect the device. The amount of thermally released gas is preferably 7 μg/cm² or less, more preferably 5 μg/cm² or less, yet more preferably 3 μg/cm² or less, or particularly preferably 1 μg/cm² or less.

The amount of thermally released gas is determined based on the dynamic headspace method. In particular, a PSA sheet subject to measurement is cut out to a 7 cm² size to obtain a measurement sample. The measurement sample is sealed in a 50 mL vial and heated at 130° C. for 30 minutes, using a headspace autosampler. As the headspace autosampler, a commercial product can be used without particular limitations. For instance, product name EQ-12031HSA available from JEOL Ltd., or a comparable product can be used. The total amount of gas released from the measurement sample is determined by gas chromatography/mass spectrometry (GC-MS). A commercial GC-MS can be used. The amount of thermally released gas is the amount of gas released per unit surface area of PSA sheet (in μg/cm²). The same measurement method is employed in the working examples described later.

The PSA sheet disclosed herein has a 180° peel strength to stainless steel (an adhesive strength) of preferably 3 N/20 mm or greater, when determined based on JIS Z 0237:2009. Having such an adhesive strength, the PSA sheet can bond well to an adherend to provide good sealing. The adhesive strength is more preferably 5 N/20 mm or greater, yet more preferably 8 N/20 mm or greater, or particularly preferably 10 N/20 mm or greater (e.g. 12 N/20 mm or greater). The maximum adhesive strength is not particularly limited. From the standpoint of preventing left-over adhesive residue, it is suitably about 20 N/20 mm or less (e.g. about 15 N/20 mm or less).

The adhesive strength of a PSA sheet is determined by the following method: A PSA sheet subject to measurement is cut to a 20 mm wide, 100 mm long size to prepare a test piece. In an environment at 23° C. and 50% RH, the adhesive face of the test piece is press-bonded to a stainless steel plate (SUS304BA plate) to obtain a measurement sample. The press-bonding is carried out by rolling a 2 kg roller back and forth once. The measurement sample is left standing in an environment at 23° C. and 50% RH for 30 minutes. Subsequently, using a tensile tester, based on JIS Z 0237:2009, the peel strength (N/20 mm) is determined at a tensile speed of 300 mm/min at a peel angle of 180°. As the tensile tester, Precision Universal Tensile Tester Autograph AG-IS 50N available from Shimadzu Corporation or a comparable product can be used. The same measurement method is employed in the working examples described later.

The PSA sheet disclosed herein preferably shows a displacement less than 2 mm in a shear holding power test carried out with a 1 kg load at 60° C. for one hour. The PSA sheet satisfying this property shows good holding power even when used at a relatively high temperature. The displacement in the shear holding power test is more preferably less than 1 mm, or yet more preferably less than 0.7 mm (e.g. less than 0.5 mm, or even less than 0.1 mm) The PSA sheet according to a particularly preferable embodiment shows no displacement (i.e. a displacement of about 0 mm) in the shear holding power test.

The shear holding power of a PSA sheet is determined by the following method: In particular, the PSA sheet subject to measurement is cut 10 mm wide, 20 mm long to prepare a test piece. In an environment at 23° C. and 50% RH, the adhesive face of the test piece is press-bonded to a stainless steel plate to obtain a measurement sample. The press-bonding is carried out by rolling a 2 kg roller back and forth once. The measurement sample is vertically suspended and left in an environment at 60° C. and 50% RH for 30 minutes. Subsequently, a 1 kg weight is attached to the free lower end of the test piece to start the test. The test is carried out for one hour and the distance that the test piece displaced (the displacement) is measured at one hour. The same measurement method is employed in the working examples described later.

The PSA sheet disclosed herein preferably has a tensile modulus per unit width in a prescribed range. In particular, the tensile modulus is preferably greater than 1000 N/cm, more preferably greater than 1400 N/cm, yet more preferably greater than 1800 N/cm, or particularly preferably greater than 2200 N/cm. The PSA sheet having such a tensile modulus has suitable rigidity and is less susceptible to creasing. It tends to provide excellent handling properties as well. The tensile modulus is preferably less than 3500 N/cm, more preferably less than 3000 N/cm, or yet more preferably less than 2800 N/cm (e.g. less than 2600 N/cm). The PSA sheet having such a tensile modulus has good adherend conformability and can well conform in a bent state to an area of the adherend including a corner.

The tensile modulus per unit width of PSA sheet is determined as follows: In particular, the PSA sheet is cut to a 10 mm wide, 50 mm long strip to prepare a test piece. The two ends of the length of the test piece are clamped with chucks in a tensile tester. In an atmosphere at 23° C., at an inter-chuck distance of 20 mm, at a speed of 50 mm/min, a tensile test is conducted using the tensile tester to obtain a stress-strain curve. Based on the initial slope of the resulting stress-strain curve, the Young's modulus (N/mm²=MPa) is determined by linear regression of the curve between two specified strain points ε1 and ε2. From the product of the resulting value and the thickness of the PSA sheet, the tensile modulus per unit width (N/cm) can be determined. As the tensile tester, a commonly known or conventionally used product can be used. For instance, AUTOGRAPH AG-IS available from Shimadzu Corporation or a comparable product can be used.

The total thickness of the PSA sheet disclosed herein is not particularly limited. It is suitably about 6 μm or greater. From the standpoint of the moisture resistance and crease resistance, etc., it is preferably 25 μm or greater, more preferably 40 μm or greater, or yet more preferably 60 μm or greater. The total thickness is suitably about 12 mm or less. From the standpoint of the adherend conformability and of reducing the thickness and weight, it is preferably 200 μm or less, more preferably 150 μm or less, or yet more preferably 120 μm or less (e.g. less than 100 μm). The total thickness of a PSA sheet here refers to the combined thickness of the substrate layer and the PSA layer, not including the thickness of the release liner described later.

### <Applications>

The PSA sheet disclosed herein has excellent moisture resistance, and in a preferable embodiment, gas emission is reduced; and therefore, it is preferably used in various applications where entry of moisture (and entry of gas if necessary) is desirably limited. For instance, the PSA sheet disclosed herein is preferably used in various electronic devices. More specifically, it is preferably used as a blocking material in the electronic devices (e.g. a sealing material to seal their internal spaces). In a more preferable embodiment, for instance, the PSA sheet is used for sealing the internal space of a magnetic disc device such as HDD. In this application, an included gas such as siloxane gas may cause damage to the device; and therefore, it is desirable to prevent such gas contamination. In a magnetic disc device employing HAMR, it is important to prevent entrance of water which badly affects the recording life. By using the PSA sheet disclosed herein as a sealing material (or a cover seal) for a HAMR magnetic disc device, a magnetic recording device having a higher density can be obtained.

FIG. 4 shows an embodiment of the magnetic disc device as a favorable example to which the art disclosed herein can be applied. FIG. 4 shows a cross-sectional diagram schematically illustrating the magnetic disc device according to an embodiment. A magnetic disc device 100 comprises a data-recording magnetic disc 110, a spindle motor 112 that rotates magnetic disc 110, a magnetic head 114 that reads and writes data on magnetic disc 110, and an actuator 116 that supplies power to magnetic head 114. Actuator 116 has a built-in linear motor not shown in the drawing. In this example of constitution, two magnetic discs 110 are included, but it is not limited to this and three or more magnetic discs may be included.

These components of magnetic disc device 100 are placed in a housing 120 which serves as a casing for magnetic disc device 100. In particular, the components of magnetic disc device 100 are contained in a box-shaped housing base member (a support structure) 122 having a top opening and the top opening of housing base member 122 is covered with a rigid cover member 124. More specifically, the top opening of housing base member 122 has a recessed portion around the inner circumference and the outer rim of cover member 124 is placed on the bottom of recessed portion 126, with cover member 124 covering the opening. A PSA sheet 101 is applied from the top face of cover member 124 so as to entirely cover the cover member 124 and the top face (outer circumference of the opening) of housing 120, that is, the entire top face of housing 120, altogether. This seals a space 140 present between housing base member 122 and cover member 124 as well as other holes and void spaces that communicate from the inside to the outside of magnetic disc device 100, thereby keeping the inside of the device air-tight. Such a sealing structure using PSA sheet 101 as the sealing material (cover seal) can be made thinner than a conventional counterpart that uses a cover member and a gasket to obtain air-tight properties. In addition, because it does not require the use of a liquid gasket, outgassing from the gasket can be eliminated as well. In this embodiment, the width of the top rim (face of the frame) of housing base member 122 is about 0.1 mm to 5 mm (e.g. 3 mm or less, or even 2 mm or less) at its narrowest portion, with the width being the distance between the outer circumference and inner circumference of the top rim of housing base member 122. When PSA sheet 101 is applied as a cover seal to the top face of housing base member 122, the top rim of housing base member 122 provides a bonding surface to PSA sheet 101, forming a portion that isolates the internal space of magnetic disc device 100 from the outside. According to the art disclosed herein, even in an application where the width of bonding surface (through-bonding-plane permeation distance) is limited, the internal space can be maintained air-tightly and dry (moisture-resistant).

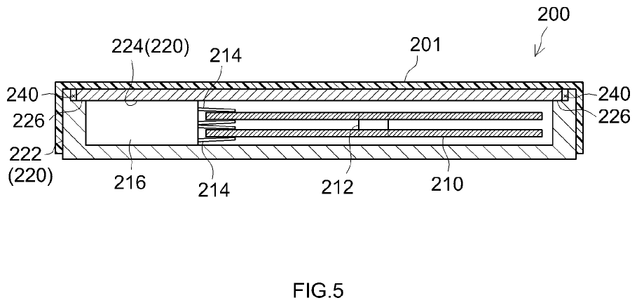

FIG. 5 shows another embodiment of the magnetic disc device to which the art disclosed herein can be applied. A magnetic disc device 200 has basically the same constitution as the embodiment described above except for the way a PSA sheet 201 is applied. Different features are described below. In magnetic disc device 200, PSA sheet 201 covers cover member 224 and the top face (outer circumference of the opening) of housing base member 222 altogether, having a margin (or an extending portion) that further extends to the side of housing 220. In particular, the extending portion is bent from the top face over the corner of top rim to the side of housing base member 222. The extending portion may be provided entirely or partially at each side forming the outer circumference of the top face of housing 220. In other words, in magnetic disc device 200, PSA sheet 201 is applied, at least partially covering the top and side faces of housing 220 in a U shape. Similar to PSA sheet 101 according to the embodiment described above, PSA sheet 201 seals a space 240 present between housing base member 222 and cover member 224 as well as other holes and void spaces that communicate from the inside to the outside of magnetic disc device 200; and because it is applied with a margin extending to the side of housing base member 222, the sealed state is extended in the in-plane directions of bonding interface. This results in a larger distance (width) of the bonding interface of PSA sheet 201 separating the outside and space 240, etc., and it inhibits moisture permeation via the bonding interface of PSA sheet 201, thereby further enhancing the moisture resistance. In this embodiment, the distance of PSA sheet 201 extending from the top rim (top edge of the side) to the side of housing 220 (i.e. the length of PSA sheet 201 that covers the side (lateral surface)) is about 1 mm or greater (e.g. 2 mm or greater, or even 3 mm or greater).

In these embodiments, cover members 124 and 224 cover magnetic discs 110 and 210 as well as actuators 116 and 216 altogether, respectively, in one piece. However, they are not limited to these. They may cover magnetic discs 110 and 210, actuators 116 and 216, and other components, separately; or they may not cover actuators 116 or 216 while covering magnetic discs 110 and 210. Even in these embodiments, by applying the PSA sheet over the cover member, the inside of the device can be made moisture-resistant and air-tight. In a magnetic disc device having such an embodiment, the moisture resistance and air-tight properties are obtained with the thin PSA sheet, thereby achieving a thin sealing structure. This can increase the capacity for housing magnetic discs, bringing about a magnetic disc device having a higher density and a larger capacity.

Matters disclosed by this description include the following:

(1) A magnetic disc device comprising

at least one data-recording magnetic disc,

a motor that rotates the magnetic disc,

a magnetic head that at least either reads or writes data on the magnetic disc,

an actuator that moves the magnetic head, and

a housing that encases the magnetic disc, the motor, the magnetic head and the actuator; wherein

the housing is provided with a cover seal, the cover seal being a PSA sheet, and

the PSA sheet has a PSA layer comprising a polymer A and a polymer B different from the polymer A, with isobutylene polymerized in each of the polymer A and the polymer B, accounting for 50% by weight or more thereof (i.e. the polymer A and the polymer B are individually formed with at least 50% (by weight) polymerized isobutylene).

(2) The magnetic disc device according to (1) above, wherein the housing comprises a box-shaped housing base member having a top opening and a cover member to cover the opening.
(3) The magnetic disc device according to (2) above, wherein the housing base member has a recessed portion around the inner circumference of the top opening and the outer rim of the cover member is placed on the bottom of the recessed portion.
(4) The magnetic disc device according to any of (1) to (3) above, wherein the cover member has a hole.
(5) The magnetic disc device according to any of (1) to (4) above, wherein the PSA sheet seals the internal space of the magnetic disc device.
(6) The magnetic disc device according to any of (1) to (5) above, wherein the PSA sheet covers and seals the top face of the housing base member of the magnetic disc device.
(7) The magnetic disc device according to any of (1) to (6) above, capable of heat-assisted magnetic recording.
(8) The magnetic disc device according to any of (1) to (7) above, wherein the PSA layer has a storage modulus below 0.5 MPa at 25° C.
(9) The magnetic disc device according to any of (1) to (8) above, wherein, in addition to the isobutylene, isoprene is copolymerized in the polymer A.
(10) The magnetic disc device according to any of (1) to (9) above, wherein the polymer A and the polymer B has a combined amount that accounts for 90% by weight or more of the PSA layer.
(11) A PSA composition comprising a polymer A and a polymer B different from the polymer A, wherein

in each of the polymer A and the polymer B, isobutylene is polymerized at a ratio of 50% by weight or higher.

(12) The PSA composition according to (11) above, wherein, in addition to the isobutylene, isoprene is copolymerized in the polymer B.
(13) The PSA composition according to (11) or (12) above, wherein the polymer A has a weight average molecular weight in the range between 1×10⁴ and 80×10⁴.
(14) The PSA composition according to any of (11) to (13) above, wherein the polymer B has a weight average molecular weight in the range between 5×10⁴ and 150×10⁴.
(15) The PSA composition according to any of (11) to (14) above, wherein the polymer A has a weight average molecular weight M_{A} and the polymer B has a weight average molecular weight M_{B}, with a M_{B}/M_{A} ratio value in the range between 5 and 100.
(16) The PSA composition according to any of (11) to (15), having a weight ratio (C_{A}/C_{B}) of the polymer A content C_{A} to the polymer B content C_{B} in the range between 70/30 and 30/70.
(17) The PSA composition according to any of (11) to (16) above, wherein the polymer A and the polymer B has a combined amount accounting for 90% by weight or more of solid content of the PSA composition.
(18) The PSA composition according to any of (11) to (17) above, wherein the isobutylene has a copolymerization ratio of 90% by weight or above in the polymer A.
(19) The PSA composition according to any of (11) to (18) above, wherein the polymer A is polyisobutylene and the polymer B is butyl rubber.
(20) The PSA composition according to any of (11) to (19) above, used for sealing an internal space of a magnetic disc device.
(21) A PSA sheet having a PSA layer comprising a polymer A and a polymer B different from the polymer A, wherein

in each of the polymer A and the polymer B, isobutylene is polymerized at a ratio of 50% by weight or above.

(22) The PSA sheet according to (21) above, wherein, in addition to the isobutylene, isobutylene and isoprene are copolymerized in the polymer B.
(23) The PSA sheet according to (21) or (22) above, wherein the polymer A has a weight average molecular weight in the range between 1×10⁴ and 80×10⁴.
(24) The PSA sheet according to any of (21) to (23) above, wherein the polymer B has a weight average molecular weight in the range between 5×10⁴ and 150×10⁴.
(25) The PSA sheet according to any of (21) to (24) above, wherein the polymer A has a weight average molecular weight M_{A} and the polymer B has a weight average molecular weight M_{B}, with a M_{B}/M_{A} ratio value in the range between 5 and 100.
(26) The PSA sheet according to any of (21) to (25) above, having a weight ratio (C_{A}/C_{B}) of the polymer A content C_{A} to the polymer B content C_{B} in the range between 70/30 and 30/70.
(27) The PSA sheet according to any of (21) to (26) above, wherein the polymer A and the polymer B has a combined amount accounting for 90% by weight or more of solid content of the PSA composition.
(28) The PSA sheet according to any of (21) to (27) above, wherein the PSA layer has a storage modulus at 25° C., G′(25° C.), of 0.09 MPa or greater and 0.29 MPa or less.
(29) The PSA sheet according to any of (21) to (28) above, used for sealing an internal space of a magnetic disc device.
(30) The PSA sheet according to any of (21) to (29) above, used for sealing an internal space of a magnetic disc device capable of heat-assisted magnetic recording.
(31) The PSA sheet according to any of (21) to (30) above, having a moisture permeability of less than 90 μg/cm² in in-plane direction of bonding interface of PSA sheet, measured based on the MOCON method, at a permeation distance of 2.5 mm over a 24-hour period.
(32) The PSA sheet according to any of (21) to (31) above, having an amount of thermally released gas of 10 μg/cm² or less, determined at 130° C. for 30 minutes by gas chromatography/mass spectrometry.
(33) The PSA sheet according to any of (21) to (32) above, having a 180° peel strength to stainless steel plate of 3 N/20 mm or greater.
(34) The PSA sheet according to any of (21) to (33) above, wherein the PSA layer has a storage modulus less than 0.5 MPa at 25° C.
(35) The PSA sheet according to any of (21) to (34) above, showing a displacement less than 2 mm in a shear holding power test carried out with a 1 kg load at 60° C. for one hour.
(36) The PSA sheet according to any of (21) to (35) above, having a tensile modulus per unit width above 1000 N/cm and below 3500 N/cm.
(37) The PSA sheet according to any of (21) to (36) above, having a total thickness of 25 am to 200 am.
(38) The PSA sheet according to any of (21) to (37) above, further comprising a substrate layer (moisture-impermeable layer), with the PSA layer provided to one face of the substrate layer.
(39) The PSA sheet according to any of (21) to (38) above, the substrate layer includes an inorganic layer.
(40) The PSA sheet according to (39) above, wherein the inorganic layer is a metal layer.
(41) The PSA sheet according to (39) or (40) above, wherein the inorganic layer is formed of aluminum or an aluminum alloy
(42) The PSA sheet according to any of (39) to (41) above, wherein the inorganic layer has a thickness of 2 am to 20 am.
(43) The PSA sheet according to any of (39) to (42) above, wherein the substrate layer comprises a resin layer in addition to the inorganic layer.
(44) The PSA sheet according to (43) above, wherein the resin layer is a polyester resin layer.
(45) The PSA sheet according to (43) or (44) above, wherein the resin layer has a thickness of 3 μm to 55 μm.
(46) The PSA sheet according to any of (38) to (45) above, wherein the substrate layer is formed of a laminate comprising an inorganic layer as well as first and second resin layers laminated atop and below the inorganic layer.
(47) A release-linered PSA sheet, comprising the PSA sheet according to any of (21) to (46) above and a release liner protecting the adhesive face of the PSA sheet, wherein the release liner is a non-silicone-based release liner free of a silicone-based release agent.
(48) A magnetic disc device comprising the PSA sheet according to any of (21) to (46) above.
(49) The magnetic disc device according to (48) above, wherein the PSA sheet seals the internal space of the magnetic disc device.
(50) The magnetic disc device according to (48) or (49) above, wherein the magnetic disc device has a housing base member and the PSA sheet is a cover seal that covers and seals the top face of the housing base member.
(51) The magnetic disc device according to any of (48) to (50), capable of heat-assisted magnetic recording.

Several working examples related to the present invention are described below, but the present invention is not intended to be limited to these examples. In the description below, “parts” and “%” are by weight unless otherwise specified.

### Example 1

By dry bonding lamination, were laminated 25 μm thick PET film (PET layer) as the first resin layer, 7 μm thick aluminum foil (Al layer) as the inorganic layer and 9 μm thick PET film (PET layer) as the second resin layer in this order from the front (outer surface side) to the backside (PSA layer side). Between each resin layer and the inorganic layer, was laminated a 3 μm thick adhesive layer. A 47 μm thick substrate layer (moisture-impermeable layer) was thus prepared.

In toluene, were dissolved Polyisobutylene A (PIRA: product name Oppanol N50 available from BASF Corporation, Mw˜34×10⁴, Mw/Mn 5.0) and butyl rubber (IIR: product name JSR BUTYL 268 available from JSR Corporation, Mw˜54×10⁴, Mw/Mn˜˜4.5, 98.3 mol % isobutylene, 1.7 mol % isoprene) at 50:50 blend ratio to prepare a PSA composition with 25% NV. The PSA composition obtained above was applied to one face (the second resin layer-side surface) of the substrate layer to have a thickness of 30 μm after dried, and allowed to dry at 120° C. for 3 minutes to form a PSA layer. A PSA sheet was thus obtained according to this Example. For protection of the surface (adhesive face) of the PSA layer, was used a release liner formed of thermoplastic film treated with release agent (product name HP-S0 available from Fujico Co., Ltd.; 50 μm thick).

### Example 2

Using a 50:50 mixture of Polyisobutylene B (PIB-B: product name Oppanol N80 available from BASF Corporation, Mw˜75×10⁴, Mw/Mn 5.0) and IIR, but otherwise in the same manner as Example 1, was prepared a PSA composition. Using the resulting PSA composition, in the same manner as Example 1, was obtained a PSA sheet according to this Example.

### Example 3

Using a 50:50 mixture of Polyisobutylene C (PIB-C: product name Oppanol B15 available from BASF Corporation, Mw˜7.5×10⁴, Mw/Mn 5.0) and IIR, but otherwise in the same manner as Example 1, was prepared a PSA composition. Using the resulting PSA composition, in the same manner as Example 1, was obtained a PSA sheet according to this Example.

### Example 4 to 5

The blend ratio of PIB-C and IIR was changed to the ratios shown in Table 1. Otherwise in the same manner as Example 3, were obtained PSA sheets according to the respective Examples.

### Example 6

In toluene, was dissolved PIB-A to prepare a PSA composition with 25% NV. Using this PSA composition, but otherwise in the same manner as Example 1, was prepared a PSA composition. Using the resulting PSA composition, in the same manner as Example 1, was obtained a PSA sheet according to this Example.

### Example 7

Using PIB-B, but otherwise in the same manner as Example 6, was prepared a PSA composition. Using the resulting PSA composition, in the same manner as Example 1, was obtained a PSA sheet according to this Example.

### Example 8

Using PIB-C, but otherwise in the same manner as Example 6, was prepared a PSA composition. Using the resulting PSA composition, in the same manner as Example 1, was obtained a PSA sheet according to this Example.

### Example 9

Using IIR, but otherwise in the same manner as Example 6, was prepared a PSA composition. Using the resulting PSA composition, in the same manner as Example 1, was obtained a PSA sheet according to this Example.

### [Moisture Permeability (Cup Method) of PSA Layer]

The moisture permeability in the thickness direction of each PSA layer was determined based on the water vapor permeability test (cup method) in JIS Z 0208. In particular, the PSA composition was applied to a releasable surface and allowed to dry to form a 50 μm thick PSA layer. The PSA layer was adhered to 2 μm thick PET film (DIAFOIL available from Mitsubishi Plastics, Inc.) with a rubber roller. The PET layer-supported PSA layer was cut to a circle of 30 mm diameter to fit the diameter of the test cup (an aluminum cup of 30 mm diameter used in the cup method of JIS Z 0208). This was used as a test sample. A prescribed amount of calcium chloride was placed in the cup and the opening of the cup was sealed with the test sample prepared above. The cup covered with the test sample was placed in a thermostat wet chamber at 60° C. and 90% RH and left standing for 24 hours. The change in weight of calcium chloride before and after this step was determined to obtain the moisture permeability (g/cm²·24 h).

For each Example, Table 1 summarizes the PSA and shows the test results of moisture permeability (cup method) (g/cm²·24 h), storage moduli G′(25° C.) (MPa), through-bonding-plane moisture permeability of PSA sheet (μg/cm²), adhesive strength (N/20 mm), shear holding power (mm), and amount of thermally released gas (μg/cm²).

TABLE 1

| | | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|
| PSA | Polymer A | Species | PIB | PIB | PIB | PIB | PIB | PIB | PIB | PIB | |
| | | Mm (×10⁴) | 34 | 75 | 7.5 | 7.5 | 7.5 | 34 | 75 | 7.5 | |
| | Polymer B | Species | IIR | IIR | IIR | IIR | IIR | | | | IIR |
| | | Mw (×10⁴) | 54 | 54 | 54 | 54 | 54 | | | | 54 |

| | | | | | | | | | |
|---|---|---|---|---|---|---|---|---|---|
| Polymer A/Polymer B | 50/50 | 50/50 | 50/50 | 60/40 | 80/20 | 100/0 | 100/0 | 100/0 | 0/100 |

| | | | | | | | | | |
|---|---|---|---|---|---|---|---|---|---|
| PSA layer's elastic modulus @25° C. (MPa ) | 0.18 | 0.24 | 0.16 | 0.24 | 0.16 | 0.28 | 0.30 | 0.30 | 0.25 |
| Moisture permeability (cup method) (g/cm² · 24 h) | 1.3 | 1.3 | 1.3 | 1.3 | 1.3 | 1.3 | 1.3 | 1.3 | 1.3 |
| Moisture permeability in in-plane direction | 7 | 10 | 5 | 14 | 16 | 28 | 41 | 19 | 30 |
| of bonding interface (μg/cm²) | | | | | | | | | |
| Adhesive strength (N/20 mm) | 11 | 6.2 | 13 | 7.6 | 5.6 | 5.5 | 1.6 | 10.0 | 2.6 |
| Shear holding power (mm) | 0.5 | 0.2 | 0.5 | 0.6 | 0.8 | 0.3 | 0.2 | 3.0 | 0.2 |
| Amount of thermally released gas (μg/cm²) | 0.8 | 0.8 | 0.8 | 0.8 | 0.8 | 0.8 | 0.8 | 0.3 | 0.8 |

As shown in Table 1, with respect to the moisture permeability test by the cup method, no differences were observed among Examples 1 to 9; however, when the moisture permeability in in-plane direction of bonding interface was precisely tested, there were notable differences among the respective Examples. In particular, with respect to the PSA sheets according to Examples 1 to 5 comprising polymers A and B, the moisture permeability in in-plane direction of bonding interface had a tendency to decrease as compared to Examples 6 to 9. These results indicate that excellent moisture resistance can be obtained with a composition where the polymers A and B are used together.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 101, 201 PSA sheets
10 substrate layer
12 first resin layer
14 inorganic layer
16 second resin layer
20 PSA layer
50 moisture permeability measurement device
52 wet chamber (first chamber)
54 dry chamber (second chamber)
56 metal plate (partition plate)
58 opening
60 measurement sample
100, 200 magnetic disc devices
110, 210 magnetic discs
112, 212 spindle motors
114, 214 magnetic heads
116, 216 actuator
120, 220 housing
122, 222 housing base member
124, 224 cover member
126, 226 recessed portions
140, 240 spaces

1. A pressure-sensitive adhesive composition comprising a polymer A and a polymer B different from the polymer A, wherein
in each of the polymer A and the polymer B, isobutylene is polymerized at a ratio of 50% by weight or higher.

2. The pressure-sensitive adhesive composition according to claim 1, wherein, in addition to the isobutylene, isoprene is copolymerized in the polymer B.

3. The pressure-sensitive adhesive composition according to claim 1, wherein the polymer A has a weight average molecular weight in the range between 1×10⁴ and 80×10⁴.

4. The pressure-sensitive adhesive composition according to claim 1, wherein the polymer B has a weight average molecular weight in the range between 5×10⁴ and 150×10⁴.

5. The pressure-sensitive adhesive composition according to claim 1, wherein the polymer A has a weight average molecular weight M_{A} and the polymer B has a weight average molecular weight M_{B}, with a M_{B}/M_{A} ratio value in the range between 5 and 100.

6. The pressure-sensitive adhesive composition according to claim 1, having a weight ratio (C_{A}/C_{B}) of polymer A content C_{A} to polymer B content C_{B} (a weight ratio of the polymer A to the polymer B) in the range between 70/30 and 30/70.

7. The pressure-sensitive adhesive composition according to claim 1, wherein the polymer A and the polymer B has a combined amount accounting for 90% by weight or more of solid content of the pressure-sensitive adhesive composition.

8. The pressure-sensitive adhesive composition according to claim 1, used for sealing an internal space of a magnetic disc device.

9. A pressure-sensitive adhesive sheet having a pressure-sensitive adhesive layer comprising a polymer A and a polymer B different from the polymer A, wherein
in each of the polymer A and the polymer B, isobutylene is polymerized at a ratio of 50% by weight or above.

10. The pressure-sensitive adhesive sheet according to claim 9, wherein the pressure-sensitive adhesive layer has a storage modulus at 25° C., G′(25° C.), of 0.09 MPa or greater and 0.29 MPa or less.
